(19) United States
(12) Patent Application Publication
(10) Pub. No.: US 2008/0315704 A1
(43) Pub. Date: Dec. 25, 2008

(54) Synchronous Machine

(75) Inventor: Rolf Vollmer, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/575,192

(22) PCT Filed: Sep. 5, 2005
(86) PCT No.: PCT/EP2005/054369

§ 371 Date: Mar. 13, 2007

(30) Foreign Application Priority Data
Sep. 15, 2004 (DE) 10 2004 044 699.7

(51) Int. Cl. H02K 3/04; H02K 21/12

(52) U.S. Cl. 310/198; 310/156.01

(57) ABSTRACT

The invention relates to a permanently excited synchronous machine (51) comprising a stator (53) and a rotor (55). Preferably, the stator (53) comprises a three-phase current winding and the rotor (55) comprises permanent magnets. The stator (53) comprises 42 slots (27) and 42 teeth (29). Each second tooth (29) is wound with a coil (39). The rotor (55) comprises 26 magnetic poles. The permanently excited synchronous machine can be configured in such a way that the useful pole pair is a prime number.

The invention relates to a permanently excited synchronous machine.

Permanently excited synchronous machines, which exhibit excitation of a rotor by means of permanent magnets, have various advantages as against electrically excited synchronous machines. For example, the rotor in a permanently excited synchronous machine requires no electric connection. In this case, permanent magnets of high energy density, that is to say a large product of flux density and field strength, prove to be superior to the permanent magnets of lesser energy. Furthermore, it is known that permanent magnets can exhibit not only a flat arrangement in relation to the air gap, but can also be positioned in a type of group configuration (flux concentration).

Disadvantageous pulsating torques can occur with permanently excited synchronous machines. Skewing a rotor or a stator of the permanently excited synchronous machine by, for example, one slot pitch, as is described for conventional motors in EP 0 545 060 B1, can lead to a reduction in the torque. In the case of permanently excited synchronous machines with conventional winding, that is to say windings that are produced using pull-in technology, it is customary to undertake skewing by one slot pitch, in order to reduce detent torques, which can also lead to pulsating torques.

It is possible, for example, to reduce the pulsating torques by means of a particular shaping of the magnets in the case of permanently excited synchronous machines that have tooth-wound coils. There is the disadvantage here that a particular shaping of the magnets leads to increased production costs.

Consequently, it is the object of the invention to specify a permanently excited synchronous machine in the case of which pulsating torques and/or detent torques are reduced in a simple way. This reduction is advantageously performed without, for example, skewing the permanent magnets.

The object set is achieved in the case of a permanently excited synchronous machine with the aid of the features as claimed in claim 1 or 4. The subclaims 2 to 3 and 5 to 9 are further advantageous developments of the permanently excited synchronous machine.

In the case of a permanently excited synchronous machine that has a stator and a rotor, the stator preferably having a three-phase winding and the rotor having permanent magnets, the stator is constructed in such a way that it has 42 slots and 42 teeth. Only every second tooth is wound with a coil in this case. The rotor is constructed in such a way that it has 26 magnetic poles. The coil that is wound around a tooth is advantageously a tooth-wound coil. Such a permanently excited synchronous machine also has 26 poles on the stator. Both stator and rotor have 26 poles.

As a result of the embodiment described, the permanently excited synchronous machine advantageously has a high utilization and a high power factor.

A high winding factor can be achieved by means of such a permanently excited synchronous machine. The combination of 26 poles on the rotor and 42 slots in the stator leads to a first possible number of detent pole pairs of pr=546. The number of detent pole pairs is yielded by multiplying the 42 slots of the stator with the 13 pole pairs of the rotor. Since the number of poles of the rotor, that is to say the number of magnetic poles of the rotor, is 26, the rotor therefore has 13 magnetic pole pairs. Consequently, the permanently excited synchronous machine has a number of magnetic poles that is a prime number. This has the advantage that the least common multiple kgV (of number of slots and number of poles) is high, which leads to a high number of detent poles with high frequency and low amplitude in the case of the pulsating torques.

A spectrum of air gap fields can be generated by means of an energized winding of the stator. Harmonic fields and a basic field can be distinguished over the circumference of 360 degrees from a consideration of this spectrum of air gap fields. A number of basic pole pairs of pg=1 results in the case of the inventive permanently excited synchronous machine. The number of basic pole pairs pg is defined as follows: pg is the lowest number of pole pairs which are yielded by Fourrier analysis of the air gap field. A number of useful pole pairs pn results from the number of rotor pole pairs, and is therefore 13, since the rotor has 13 magnetic pole pairs.

This results in the use of a thirteenth harmonic for the permanently excited synchronous machine. The fundamental wave and the harmonics of a field profile in an air gap of an electric machine can be determined, for example, by means of Fourier analysis.

In an advantageous refinement, the winding of the stator is designed in such a way that, in particular, disturbing harmonics such as the fifth and seventh harmonic have only a small amplitude. The fifth and the seventh harmonic are disadvantageous, in particular, because they have opposite directions of rotation and lead with the rotor speed in each case to torque fluctuations with the 6th harmonic.

The 5th and 7th harmonics of the rotor field rotate at the rotor frequency. The stator field 5 pn rotates at 1/5 of the rotor frequency counter to the rotor rotation, and the stator field 7 pn rotates at 1/7 of the rotor frequency in the direction of rotation of the rotor. The stator and rotor fields with 5 pn and 7 pn meet one another 6 pn times per rotor revolution, and produce torque ripple with 6 pn per rotor revolution.

A reduced formation of detent torque results from the use of the inventive permanently excited synchronous machine with a specific combination from a number of slots in the stator and a specific number of rotor poles. The lesser formation of detent torque is a result, in particular, of the winding design, in the case of which only every second tooth of the stator is wound with a tooth coil. The stator of the permanently excited synchronous machine advantageously has a winding in accordance with FIG. 2. The winding is described in more detail in the description of the FIG.s.

A further object of the invention is to specify a permanently excited synchronous machine having a specific stator laminate section and a specific winding (see FIG. 2) for energization by three-phase current, in the case of which the permanently excited synchronous machine exhibits small detent torques and small harmonics without skewing of stator and/or rotor. The harmonics relate to the magnetic field profile in an air gap between stator and rotor. Consequently, the harmonics also relate to the EMF, and may therefore also be described as EMF harmonics.

The inventive permanently excited synchronous machine has advantages over the prior art, particularly in the case of low speed and high torques. Such an application with low speed and high torques is typically found in the case of torque motor applications. The permanently excited synchronous machine is thus advantageously a torque motor.

An advantageous refinement of the permanently excited synchronous machine has a wound tooth and neighboring slots of the wound tooth, the wound tooth and the neighboring slots having parallel flanks. Both the tooth and the slots have flanks. These flanks run in parallel. This has, for example, the advantage of simple mounting of the winding of the tooth. The winding is, in particular, a tooth winding, the slots that are present on both sides of a tooth being filled by the winding of the tooth.

In a further advantageous refinement, the stator is wound with flat wire or with flat litz wire. This enables a higher degree of filling of the slots with copper.

Furthermore, the permanently excited synchronous machine can be configured in such a way that a phase is assigned seven coils, all seven coils of the phase being connected in series. A phase thus has seven coils that can be energized in a series connection.

A further advantageous refinement of the permanently excited synchronous machine has a stator that has wide teeth and narrow teeth, a slot pitch width αns for the narrow teeth being in the range of 8°>αns>1°, and a slot pitch width αnb for the broad teeth being in the range of 9°<αnb<17°, in which case it holds that αnb+αns=360°/21.

Furthermore, the permanently excited synchronous machine can be configured in such a way that there is a hole number of q=7/13. The hole number q specifies the number of slots per pole over which the winding of a phase is divided, and so q is the number of slots per pole and phase.

In order to keep low detent torques of permanent magnets of the rotor with stator teeth, it is necessary to select the number of slots and number of poles such that the least, common multiple is as high as possible. This is achieved when the number of pole pairs (number of useful pole pairs) is a prime number. The number of useful pole pairs is thus a prime number.

According to the invention, a stator section with 42 slots and 26 poles, and a winding with the number of basic pole pairs pg=1 and a number of useful pole pairs pn=13 are determined. The least common multiple is thus 546 (kgV(42, 26)=546). Consequently, there is a number of reluctance detent pole pairs of pr=546, and thus relatively small detent torques, because the rotor field, leading to detenting, of the number of magnetic pole pairs prm=273 (=21st rotor harmonic) has a small amplitude.

The slot pitch width is advantageously between 0.66 and 1.23 of the pole pitch width of the rotor.

The invention and advantageous refinements of the invention are explained in more detail below with the aid of the drawing, in which:

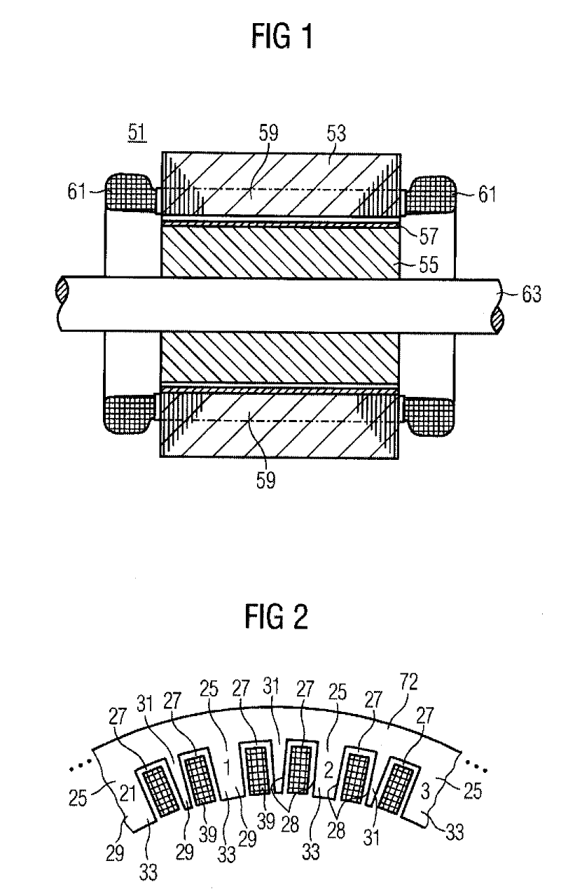

FIG. 1 shows a schematic of the design of a permanently excited synchronous machine,

FIG. 2 shows a schematic section of a laminate section of a stator of a permanently excited synchronous machine and

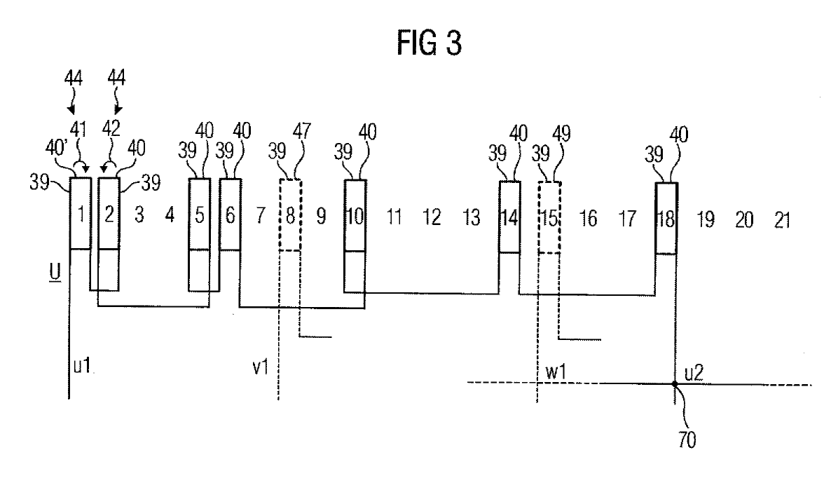

FIG. 3 shows a winding diagram.

The illustration in accordance with FIG. 1 shows a permanently excited synchronous machine 51 that has a stator 53 and a rotor 55. The rotor 55 has permanent magnets 57. The stator 53 has coils 59, the profile of the coil 59 inside the laminated stator 53 being illustrated by dots and dashes. A winding is constructed with the aid of the coil 59. The coils 59 construct winding overhangs 61. The permanently excited synchronous machine 51 is provided for driving a shaft 63.

The illustration in accordance with FIG. 2 shows a schematic section of a laminate section 72. The laminate section 72 relates to the stator 53 of the permanently excited synchronous machine 51. The laminate section 72 has teeth 29 and slots 27. When a tooth 29 is wound, it is a wound tooth 25. The wound teeth 25 are enumerated from 1 to 21. The stator 53 with the laminate section 72 has 21 wound teeth. A tooth is wound by mounting a coil 39, for example. This can be done with particular ease when the wound tooth 25 and the neighboring slots 27 of the wound tooth 25 have parallel flanks. The teeth 29 and the slots 27 have flanks 28. These flanks 28 are of parallel design. The schematically illustrated section of the laminate section 72 shows that winding takes place only for every second tooth 29. Every second tooth 29 is thus wound around with a tooth coil 39. Prefabricated preformed coils can advantageously be used to this end. Owing to the parallelism of the tooth 25 that is to be wound around, and to the parallelism of the slots 27 that are to be filled by the coil 39, preformed coils made from flat wire can advantageously be used such that there is a particularly high copper filling factor in the slots 27.

Permanently excited synchronous machines that can, in particular, be used as motors can be built with low losses and thus a high utilization owing to the measures described.

The laminate section 72 alternately has a narrow tooth 31 and a wide tooth 33. By means of the targeted selection of the slot pitch width of the wide tooth 33 and of the narrow tooth 31, it is possible, together with the selection of the winding connections, particularly in accordance with FIG. 3, to set an air gap field of a working shaft high, and to set the disturbing harmonics low. A low torque ripple is thereby attained in addition to the high utilization.

The illustration in accordance with FIG. 3 shows a first winding diagram for a stator that has 42 slots. The relevant rotor has 26 poles (magnetic poles), that is to say 13 pole pairs, the rotor not being illustrated in FIG. 3. In accordance with the winding diagram according to FIG. 3, the stator 21 has coils 39, seven coils 39 being illustrated for a phase U in accordance with FIG. 3. The coils 40 of the phase U are illustrated in FIG. 3 with a continuous line. The winding diagram relates to a permanently excited synchronous machine that can be energized by three phases U, V, W of a three-phase current. The winding of the phase U is illustrated in FIG. 3 with all the coils 40. For the windings of the phases V and W, it is in each case only the first coil 47 that is illustrated for the phase V, and the coil 49 for the phase W. The coils 47 and 49 of the phases V and W are illustrated by dashes in FIG. 3. The winding of the phases V and W corresponds to the winding of the phase U, the winding not being completely illustrated, in order to provide a better overview. Connections of the phases U, V and W are denoted by u1, u2, v1, v2, w1 and w2.

The illustration in accordance with FIG. 3 shows teeth that are symbolized by numbers from 1 to 21, the teeth being wound with coils 39. A schematic preparation of the winding diagram is selected for the purpose of simple illustration. Every second tooth of a permanently excited synchronous machine, that has a winding diagram according to FIG. 3, is wound. In FIG. 3, only the wound teeth are numbered from 1 to 21 and illustrated as numbers. An unwound tooth, which is not illustrated in FIG. 3, is located between two wound teeth that are numbered from 1 to 21. A first coil 39 of the phase U is wound around the tooth 1. It is followed by a winding around the tooth 2. The tooth 2 is the second windable tooth. Between the tooth 1 and the tooth 2 there is further an unwound tooth that is not illustrated in FIG. 3. There is a corresponding situation for the teeth 3, 4, 5, 6 etc, between which there is a further respective tooth that is, however, not illustrated.

The coil around the tooth 2 has a winding direction opposite to the coil 40 around the tooth 1. The winding therefore has two different winding directions 44, a first winding direction 41 and a second winding direction 42. The coil 40 around the tooth 2 follows for the phase U a coil 40 around the tooth 5. Thereafter, coils 40 follow around the teeth 6, 10, 14 and 18. The winding directions 40 of the coils 40 of the phase U differ. The coil around the tooth 1 has a first winding direction 41, and the coil 40 around the tooth 2 has a second winding direction 42, the first winding direction 41 being opposite to the second winding direction 42. Clearly, in FIG. 3 the first winding direction e 41 runs clockwise, and the second winding direction z 42 runs anticlockwise. The following table conveys the winding directions of the phase U for the coils around the teeth 1, 2, 5, 6, 10, 14 and 18:

| Tooth of the | | | | | | | |
|---|---|---|---|---|---|---|---|
| phase U | 1 | 2 | 5 | 6 | 10 | 14 | 18 |
| Winding | e 41 | z 42 | z 42 | E 41 | z 42 | e 41 | e 41 |
| direction | | | | | | | |

The first coil 47 of the phase V is located on the tooth 8. This coil 47 is followed by a coil around the tooth 9 which is, however, not illustrated. The coil around the tooth 9 has a winding direction opposite to the coil 47 around the tooth 8. Seven coils are also provided for the phase V, only one coil 47 of these 7 coils being illustrated in FIG. 3. The winding directions 44 of the phase V and the phase W correspond to the winding directions of the phase U. The first coil 49 of the phase W is located on the tooth 15. 7 coils are also provided for the phase W, only one coil 49 of these 7 coils being illustrated in FIG. 3. The seven coils, which are in each case assigned to a phase, are connected in series.

The connection u2 is designed as a star point 70 for the phases U, V and W. The connections u2, v2 and w2 together form the star point 70, the connections v2 and w2 not being illustrated in FIG. 3. The leading coils 47 and 49 of the phases V and W are, however, illustrated in FIG. 3.

1-9. (canceled)

10. A permanently excited synchronous machine, comprising:
a stator having a winding, said stator having 42 slots and 42 teeth, only every second tooth being wound with a coil; and
a rotor having permanent magnets, said rotor interacting with said stator, said rotor having 26 magnetic poles.

11. The permanently excited synchronous machine of claim 10, wherein the stator winding is a three-phase winding.

12. The permanently excited synchronous machine of claim 11, wherein seven coils are assigned for each phase and all seven coils for each phase are connected in series.

13. The permanently excited synchronous machine of claim 10, wherein said coils are wound on respective wound teeth, coils being numbered sequentially 1-21, respective coils having either a first or second winding direction, said first winding direction being opposite to said second winding direction,
a) for the first phase a first coil 1 is wound in the first winding direction, a second wound tooth 2 is wound in the second winding direction, a third wound tooth 5 is wound in the second winding direction and a fourth wound tooth 6 is wound in the first winding direction, a fifth wound tooth 10 is wound in the second winding direction, a sixth wound tooth 14 is wound in the first winding direction, and a seventh wound tooth 18 is wound in the first direction, said coils for the first phase being connected in series,
b) for the second phase a first coil 8 is wound in the first winding direction, a second coil 9 is wound in the second winding direction, a third coil 12 is wound in the second winding direction, a fourth coil 13 is wound in the first winding direction, fifth coil 17 is wound in the second winding direction, a sixth coil 21 is wound in the first winding direction, and a seventh coil 4 is wound in the first winding direction, said coils for the second phase being connected in series, and
c) for the third phase a first coil 15 is wound in the first winding direction, a second coil 16 is wound in the second winding direction, a third coil 19 is wound in the second winding direction, a fourth coil 20 is wound in the first winding direction, a fifth coil 3 is wound in the second winding direction, and a sixth coil 7 is wound in the first winding direction and a seventh coil is wound in the first winding direction, said coils for the third phase being connected in series.

14. A permanently excited synchronous machine, comprising:
a rotor having permanent magnets; and
a stator having 42 slots and 42 teeth and a three-phase winding, said stator interacting with said rotor, only every second tooth of said teeth being wound with a coil, said coils having a first winding direction designated as e and a second winding direction designated as z in the winding chart provided below, said first winding direction e being opposite to said second winding direction z, said wound teeth being wound with said coils as follows:

| Wound | | | | | | | | | | | | | | | | | | | | | |
|---|---|---|---|---|---|---|---|---|---|---|---|---|---|---|---|---|---|---|---|---|---|
| tooth | 1 | 2 | 3 | 4 | 5 | 6 | 7 | 8 | 9 | 10 | 11 | 12 | 13 | 14 | 15 | 16 | 17 | 18 | 19 | 20 | 21 |
| Phase | E | z | | | z | e | | | | Z | | | | e | | | | e | | | |
| U | | | | | | | | | | | | | | | | | | | | | |
| Phase | | | | e | | | | e | z | | | z | e | | | | z | | | | e |
| V | | | | | | | | | | | | | | | | | | | | | |
| Phase | | | E | | | | e | | | | e | | | | E | z | | | z | e | |
| W | | | | | | | | | | | | | | | | | | | | | |

15. The permanently excited synchronous machine of claim 14, wherein the rotor has 26 magnetic poles.

16. The permanently excited synchronous machine of claim 10, further comprising a star point circuit.

17. The permanently excited synchronous machine of claim 10, wherein a wound tooth and neighboring slots of said wound tooth have parallel flanks.

18. The permanently excited synchronous machine of claim 10, wherein said stator (53) is wound with a flat wire.

19. The permanently excited synchronous machine of claim 10, wherein said stator is wound with a flat wire or with a flat litz wire.

20. The permanently excited synchronous machine of claim 10, wherein said stator has wide teeth and narrow teeth, said narrow teeth having a slot pitch width ans for in the range of 8°>αns>1°, and said the broad teeth having a slot pitch width anb in the range of 9<αnb<17°, so that αnb+αns=360°/21.

21. The permanently excited synchronous machine of claim 10, having a hole number q=7/13.

22. The permanently excited synchronous machine of claim 10, wherein the coil wound around a tooth is a tooth-wound coil.

23. A torque motor, comprising:
a stator having a winding, said stator having 42 slots and 42 teeth, only every second tooth being wound with a coil; and
a rotor having permanent magnets, said rotor interacting with said stator, said rotor having 26 magnetic poles.

24. A permanently excited synchronous machine, comprising:
a stator having a winding, said stator having slots and teeth, no more than every second tooth being wound with a coil; and
a rotor having permanent magnets, said rotor interacting with said stator, said rotor having 26 magnetic poles.

25. The permanently excited synchronous machine of claim 10 having a slot pitch width 0.66 and 1.23 of the pole pitch width of the rotor.
